(19) United States
(12) Patent Application Publication
(10) Pub. No.: US 2026/0241920 A1
(43) Pub. Date: Aug. 20, 2026

(54) Vehicle Control Apparatus and Vehicle Control Method

(71) Applicant: Astemo, Ltd., Chiyoda-ku, Tokyo (JP)

(72) Inventors: Tatsuya SHIMASAKI, Hitachinaka-shi, Ibaraki (JP); Satoshi KANEKO, Hitachinaka-shi, Ibaraki (JP); Naoki SHINOHARA, Hitachinaka-shi, Ibaraki (JP)

(21) Appl. No.: 19/164,883

(22) PCT Filed: Jan. 30, 2024
(86) PCT No.: PCT/JP2024/002760

§ 371 Date: Sep. 12, 2025

(30) Foreign Application Priority Data
Jun. 1, 2023 (JP) 2023-090743

(51) Int. Cl. B60W 30/045; B60W 10/08; B60W 10/119; B60W 10/192

(52) U.S. Cl. CPC B60W 30/045; B60W 10/08; B60W 10/119; B60W 10/192; B60W 2520/10; B60W 2540/18; B60W 2710/182

(57) ABSTRACT

In one mode of a vehicle control apparatus and a vehicle control method according to the present invention, at primary steering, which is a state in which the steering wheel of the vehicle is rotated from its neutral position in one of the right and left directions, first braking force generated by a front driving and braking apparatus and first driving force generated by a rear driving and braking apparatus are calculated, based on the speed of the vehicle and physical quantities relating to the steering angle of the vehicle, and a first control command for generating the first braking force and the first driving force is output. In this way, the turning performance of the vehicle can be improved, without generating acceleration/deceleration not intended by the driver.

### TECHNICAL FIELD

The present invention relates to vehicle control apparatuses and vehicle control methods.

### BACKGROUND ART

The vehicle motion control apparatus according to Patent Document 1 includes a yaw moment control unit that controls the yaw moment generated in a vehicle by the difference in driving and braking force between the right and left wheels of the vehicle based on the lateral motion of the vehicle. In a first period in which it is predicted that the lateral motion of the vehicle will change from a state in which the vehicle exhibits a lateral motion in one of the right and left directions to a state in which the vehicle exhibits a lateral motion in the other direction, the yaw moment control unit controls the yaw moment generated in the vehicle. In a second period in which it is predicted that the lateral motion of the vehicle will change from a state in which the vehicle exhibits a lateral motion to a state in which the vehicle exhibits no lateral motion, the yaw moment control unit reduces the absolute value of the deceleration generated in the vehicle to be less than the absolute value of the deceleration generated in the vehicle in the first period.

### REFERENCE DOCUMENT LIST

### Patent Document

Patent Document 1: JP 2018-065466 A

### SUMMARY OF THE INVENTION

### Problem to be Solved by the Invention

In vehicle motion control in which the yawing motion of a vehicle is controlled based on the longitudinal acceleration of the vehicle and the difference in driving and braking force between the right and left wheels of the vehicle, acceleration/deceleration not intended by the driver occurs, and the driver may feel a sense of discomfort.

The present invention has been made in view of conventional circumstances, and it is an object of the present invention to provide a vehicle control apparatus and a vehicle control method that can improve the turning performance of a vehicle, without generating acceleration/deceleration not intended by the driver.

### Means for Solving the Problem

In one mode of the present invention, at primary steering, which is a state in which the steering wheel of a vehicle is rotated from its neutral position in one of the right and left directions, first braking force generated by a front driving and braking apparatus and first driving force generated by a rear driving and braking apparatus are calculated, based on the speed of the vehicle and physical quantities relating to the steering angle of the vehicle, and a first control command for generating the first braking force and the first driving force is output.

### Effects of the Invention

According to the present invention, the turning performance of a vehicle can be improved, without generating acceleration/deceleration not intended by the driver.

### BRIEF DESCRIPTION OF THE DRAWINGS

FIG. 1 illustrates an overall configuration of a vehicle control system 1.

FIG. 2 is a block diagram schematically illustrating driving and braking control systems.

FIG. 3 is a block diagram illustrating turning control according to a first example.

FIG. 4 illustrates an overview of a torque map.

FIG. 5 illustrates the relationship between a vehicle speed V and a driving and braking torque T.

FIG. 6 illustrates the relationship between an absolute value |Δθ| of a steering angular velocity Δθ and driving and braking torque T.

FIG. 7 is a graph illustrating the relationship between the absolute value of a steering angle θ and a second gain G2.

FIG. 8 is a graph illustrating the relationship between the brake operation quantity and a third gain G3.

FIG. 9 illustrates change in vehicle state when the turning control according to the first example is executed.

FIG. 10 is a block diagram illustrating turning control according to a second example.

FIG. 11 illustrates change in vehicle state when the turning control according to the second example is executed.

FIG. 12 is a block diagram illustrating turning control according to a third example.

FIG. 13 is a block diagram illustrating a primary steering/secondary steering determination unit and a rate limit determination unit according to the third example.

FIG. 14 illustrates change in vehicle state when the turning control according to the third example is executed.

FIG. 15 is a flowchart illustrating a turning control process in which the primary steering or the secondary steering is determined.

### MODE FOR CARRYING OUT THE INVENTION

Hereinafter, examples of a vehicle control apparatus and a vehicle control method according to the present invention will be described with reference to the drawings.

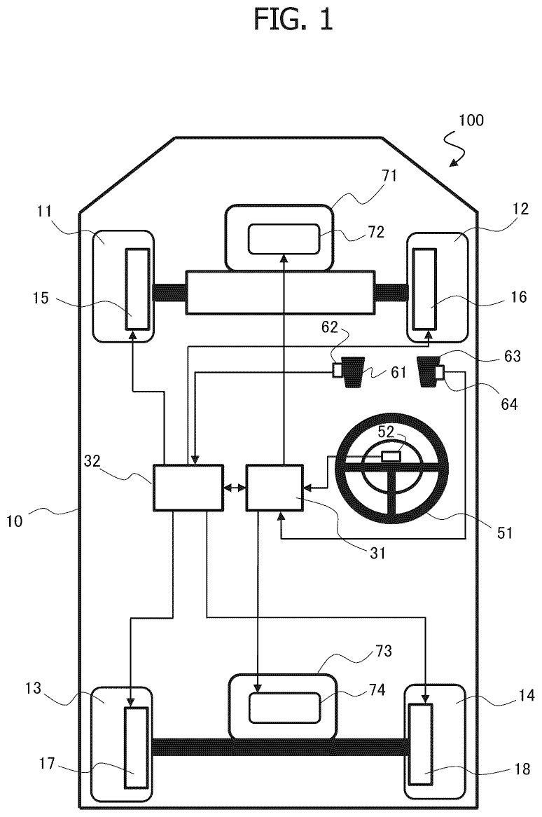

FIG. 1 illustrates an overall configuration of vehicle control system 1 mounted in a vehicle 10.

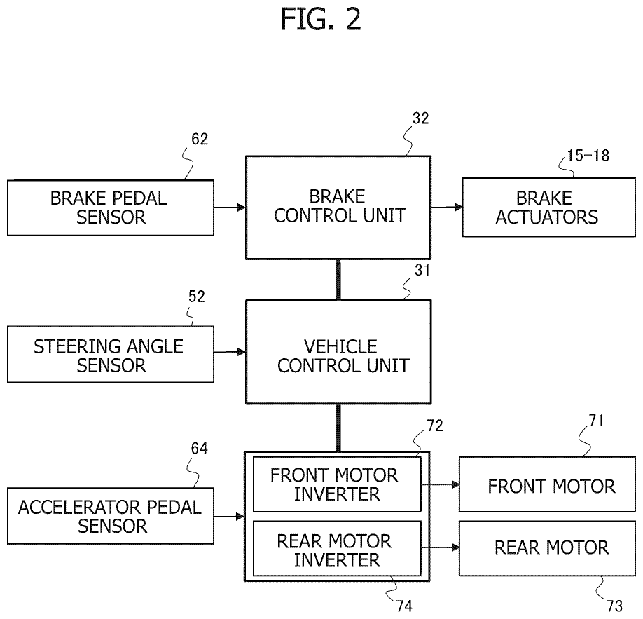

FIG. 2 is a block diagram schematically illustrating driving and braking control systems in vehicle control system 1.

Vehicle 10 includes a pair of right and left front wheels 11 and 12 and a pair of right and left rear wheels 13 and 14.

In addition, vehicle 10 includes a front motor 71 that applies driving force to front wheels 11 and 12 and a rear motor 73 that applies driving force to rear wheels 13 and 14. These motors 71 and 73 function as driving force actuators that apply driving force to vehicle 10.

A front motor inverter 72 controls driving of front motor 71, and a rear motor inverter 74 controls driving of rear motor 73.

Front motor inverter 72 and rear motor inverter 74 each include an inverter circuit, and an electronic control unit (ECU) that outputs a signal for controlling its corresponding inverter circuit.

The ECU in front motor inverter 72 and the ECU in rear motor inverter 74 each acquire information about the operation quantity of an accelerator pedal 63 from an accelerator pedal sensor 64, and each output a control signal based on a target driving force based on the operation quantity of accelerator pedal 63 to its corresponding inverter circuit. In this way, the driving force based on the operation quantity of accelerator pedal 63 is generated by front motor 71 or rear motor 73.

In addition, vehicle 10 includes a steering apparatus that changes the steering angle of front wheels 11 and 12, which are the steered road wheels, based on the steering operation of a steering wheel 51.

Steering wheel 51 includes a steering angle sensor 52 that detects the rotation angle of steering wheel 51 as the steering angle.

In addition, vehicle 10 includes a braking apparatus.

The braking apparatus includes a brake control unit 32, a brake pedal sensor 62 that detects the operation quantity of a brake pedal 61, and brake actuators 15, 16, 17, and 18 provided at road wheels 11, 12, 13, and 14, respectively.

Brake control unit 32 controls the friction braking force applied by brake actuators 15, 16, 17, and 18 to their respective road wheels 11, 12, 13, and 14, based on the output of brake pedal sensor 62.

Front motor 71 and rear motor 73 are each used as a power source, and each execute a regenerative operation selectively. Front motor 71 constitutes a front driving and braking apparatus that applies driving and braking force to front wheels 11 and 12, and rear motor 73 constitutes a rear driving and braking apparatus that applies driving and braking force to rear wheels 13 and 14.

A vehicle control unit 31 acquires a signal about the steering angle from steering angle sensor 52.

Vehicle control unit 31 outputs a control command about driving and braking to brake control unit 32, the ECU in front motor inverter 72, and the ECU in rear motor inverter 74.

The ECU in front motor inverter 72, the ECU in rear motor inverter 74, brake control unit 32, and vehicle control unit 31 each include a microcomputer, which includes a microprocessor unit (MPU), a read-only memory (ROM), a random access memory (RAM), etc. These MPUs execute programs stored in their respective ROMs as storage units, so as to implement various kinds of functions.

In vehicle control system 1, when vehicle 10 turns, the microcomputer as a control unit included in vehicle control unit 31, which is a vehicle control apparatus, executes turning control that improves the turning performance of vehicle 10, without generating acceleration/deceleration not intended by the driver.

In the turning control, at primary steering, which is a state in which steering wheel 51 is rotated from its neutral position in one of the right and left directions, vehicle control unit 31 calculates first braking force generated by the front driving and braking apparatus and first driving force generated by the rear driving and braking apparatus, based on the speed of vehicle 10 and physical quantities relating to the steering angle of vehicle 10, and outputs a first control command for generating the first braking force and the first driving force.

Because of this turning control, the lateral acceleration of vehicle 10 increases. As a result, because the lateral movement quantity increases, the turning performance of vehicle 10 improves.

### FIRST EXAMPLE

Hereinafter, turning control according to a first example will be described.

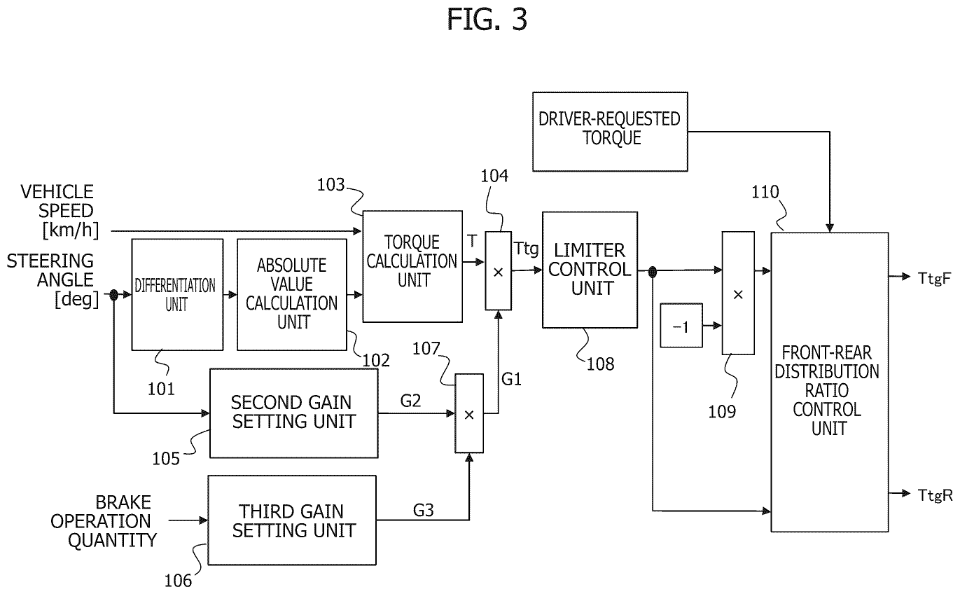

FIG. 3 is a block diagram illustrating functional units of vehicle control unit 31 for turning control according to a first example.

A differentiation unit 101 acquires a signal indicating steering angle θ [deg] from steering angle sensor 52, and calculates steering angular velocity Δθ [deg/s] by differentiating steering angle θ with respect to time.

When steering wheel 51 is at its neutral position (in other words, the straight position), steering angle θ is 0. When steering wheel 51 is rotated from the neutral position in the right or left direction, the direction is represented by a sign such as positive “+” or negative “−”.

An absolute value calculation unit 102 acquires a signal indicating steering angular velocity Δθ from differentiation unit 101, and obtains absolute value |Δθ| of steering angular velocity Δθ.

A torque calculation unit 103 acquires a signal indicating absolute value |Δθ| of steering angular velocity Δθ, and a signal indicating vehicle speed V [km/h], and obtains driving and braking torque T [Nm] (T≥0) applied to the front and rear wheels, based on absolute value |Δθ| of steering angular velocity Δθ and vehicle speed V

In this operation, torque calculation unit 103 refers to a torque map in which driving and braking torque T is set for each combination of absolute value |Δθ| of steering angular velocity Δθ and vehicle speed V, and searches for driving and braking torque T matching a combination of absolute value |Δθ| of steering angular velocity Δθ and vehicle speed V in question.

The torque map is stored in a non-volatile memory such as the ROM of the microcomputer included in vehicle control unit 31.

The present example is not limited to this configuration in which torque calculation unit 103 obtains driving and braking torque T by using a torque map. Torque calculation unit 103 may calculate driving and braking torque T by executing an arithmetic process, using absolute value |Δθ| of steering angular velocity Δθ and vehicle speed V as variables.

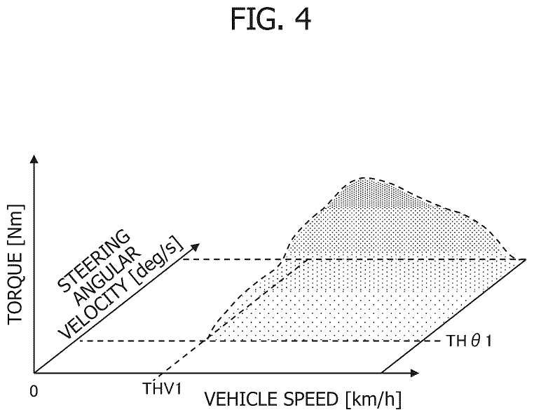

FIG. 4 illustrates an overview of the torque map.

In the torque map, driving and braking torque T is set to 0 in the area in which vehicle speed V is equal to or less than a first threshold THV1 (THV1>0) and in the area in which absolute value |Δθ| of steering angular velocity Δθ is equal to or less than a first threshold THθ1 (THθ1>0).

First threshold THV1, which is a first speed threshold, is set to approximately 40 km/h, for example, and first threshold THθ1, which is a first angular velocity threshold, is set to approximately 50 deg/s, for example.

In the area in which driving and braking torque T is set to 0, a driving and braking torque command in the turning control is finally set to 0. That is, in this area, the turning control is not executed, in other words, the turning control is substantially canceled.

On the other hand, in the torque map, in the area in which vehicle speed V exceeds first threshold THV1 and absolute value |Δθ| of steering angular velocity Δθ exceeds first threshold THθ1, driving and braking torque T is set to a value greater than 0.

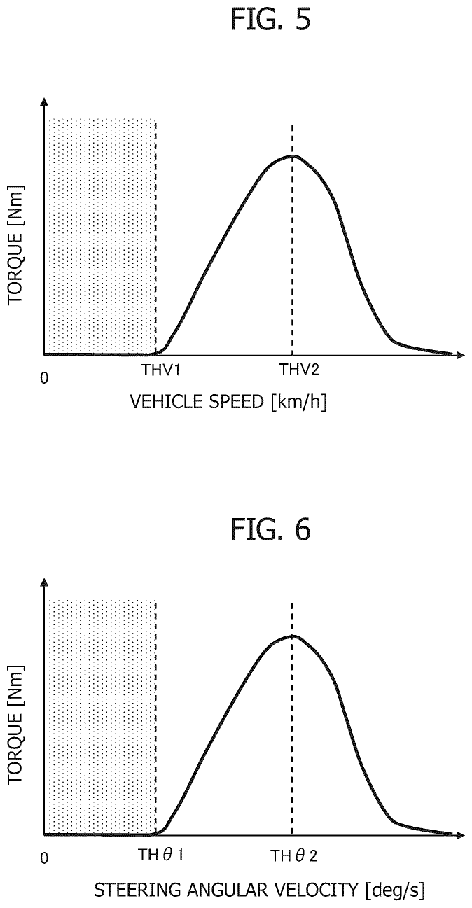

FIG. 5 illustrates the relationship between vehicle speed V and driving and braking torque T in the torque map illustrated in FIG. 4.

As described above, when vehicle speed V is equal to or less than first threshold THV1, driving and braking torque T is set to 0, and the turning control is not executed.

In addition, in the area in which vehicle speed V exceeds first threshold THV1, driving and braking torque T represents a local maximum value (maximum value).

That is, assuming that vehicle speed V corresponding to when driving and braking torque T represents the local maximum value is expressed as a second threshold THV2, which is a second speed threshold, driving and braking torque T increases as vehicle speed V increases when vehicle speed V is between first threshold THV1 and second threshold THV2. In the area in which vehicle speed V exceeds second threshold THV2, driving and braking torque T decreases as vehicle speed V increases.

FIG. 6 illustrates the relationship between absolute value |Δθ| of steering angular velocity Δθ and driving and braking torque T in the torque map illustrated in FIG. 4.

As described above, when absolute value |Δθ| of steering angular velocity Δθ is equal to or less than first threshold THθ1, driving and braking torque T is set to 0, and the turning control is not executed.

In addition, in the area in which absolute value |Δθ| of steering angular velocity Δθ exceeds first threshold THθ1, driving and braking torque T represents a local maximum value (maximum value).

That is, assuming that absolute value |Δθ| corresponding to when driving and braking torque T represents the local maximum value is expressed as a second threshold THθ2 (second angular velocity threshold), driving and braking torque T increases as absolute value |Δθ| of steering angular velocity Δθ increases when absolute value |Δθ| of steering angular velocity Δθ is between first threshold THθ1 and second threshold THθ2. In the area in which absolute value |Δθ| of steering angular velocity Δθ exceeds second threshold THθ2, driving and braking torque T decreases as absolute value |Δθ| of steering angular velocity Δθ increases.

As described above, because the effectiveness of the turning control is low when vehicle speed V is equal to or less than first threshold THV1 and/or when absolute value |Δθ| of steering angular velocity Δθ is equal to or less than first threshold THθ1, the torque map is set such that the turning control is not executed in any of these cases.

On the other hand, the torque map is set such that the turning control is executed in the area in which vehicle speed V exceeds first threshold THV1 and in which absolute value |Δθ| of steering angular velocity Δθ exceeds first threshold THθ1.

However, when vehicle speed V and absolute value |Δθ| of steering angular velocity Δθ exceed second threshold THV2 and second threshold THθ2, respectively, running of vehicle 10 may become unstable by the turning control. Thus, the torque map is set such that the driving and braking force applied by the turning control is reduced.

Torque calculation unit 103 outputs a signal indicating driving and braking torque T obtained based on absolute value |Δθ| of steering angular velocity Δθ and vehicle speed V to a first multiplication unit 104.

First multiplication unit 104 multiplies driving and braking torque T by a first gain G1, and outputs the resultant product as a signal indicating a requested driving and braking torque Ttg.

First gain G1 is set based on second gain G2, which is based on steering angle θ, and third gain G3, which is based on the brake operation quantity (G1=G2×G3).

A second gain setting unit 105 acquires the signal indicating steering angle θ and outputs a signal indicating second gain G2 based on steering angle θ.

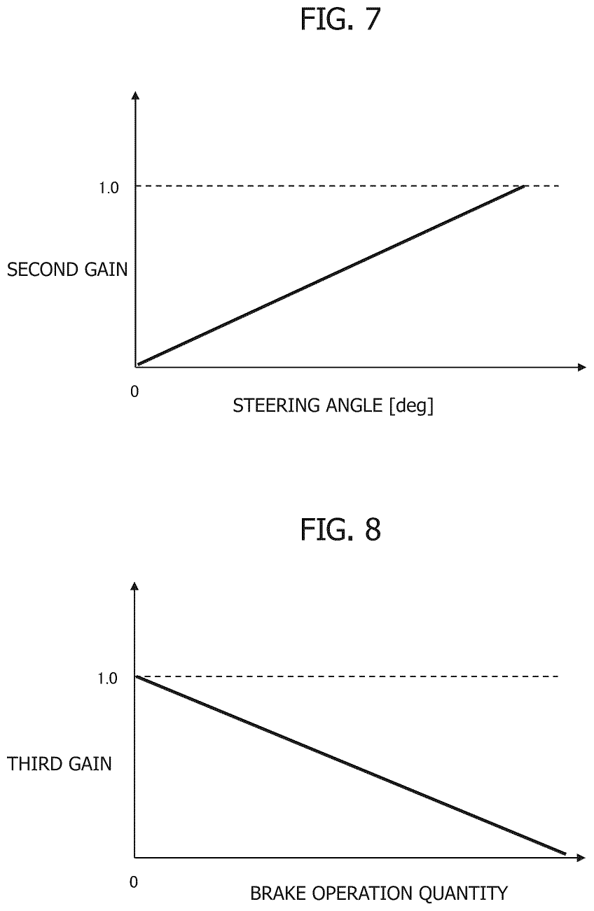

FIG. 7 illustrates the relationship between the absolute value of steering angle θ and second gain G2 (1.0≥G2≥0).

Second gain setting unit 105 sets second gain G2 to 0 when steering angle θ is 0 at its neutral position (neutral angle). Second gain setting unit 105 sets a greater value as second gain G2 within the range of 1.0≥G2≥0, as the absolute value of steering angle θ increases. That is, when steering angle θ represents an angle around the neutral position, second gain G2 based on steering angle θ is set to 0 or a value approximately 0. Thus, requested driving and braking torque Ttg output by first multiplication unit 104 is set to 0 or a value approximately 0. Requested driving and braking torque Ttg increases as steering angle θ deviates further from the neutral position.

A third gain setting unit 106 acquires a signal indicating the brake operation quantity (in other words, the operation quantity of brake pedal 61) from brake pedal sensor 62, and outputs a signal indicating third gain G3 based on the brake operation quantity.

FIG. 8 illustrates the relationship between the brake operation quantity and third gain G3 (1.0≥G3≥0).

When the brake operation quantity is 0 and no brake operation is executed, third gain setting unit 106 sets third gain G3 to 1.0. Third gain setting unit 106 decreases third gain G3 to close to 0 as the brake operation quantity increases (in other words, the request for friction braking force increases).

That is, as the driver increases the brake operation quantity, requested driving and braking torque Ttg output by first multiplication unit 104 decreases. In this way, the application of the driving and braking force by the turning control does not hinder implementation of a sudden deceleration request.

A second multiplication unit 107 acquires a signal indicating second gain G2 from second gain setting unit 105, and acquires a signal indicating third gain G3 from third gain setting unit 106.

Next, second multiplication unit 107 multiplies second gain G2 by third gain G3, and outputs the resultant product to first multiplication unit 104 as first gain G1 (G1=G2×G3). First multiplication unit 104 multiplies first gain G1 based on second gain G2 and third gain G3 by driving and braking torque T obtained by torque calculation unit 103, and outputs the resultant product as a signal indicating requested driving and braking torque Ttg (Ttg=T×G1).

A limiter control unit 108 acquires the signal indicating requested driving and braking torque Ttg output by first multiplication unit 104, limits requested driving and braking torque Ttg to a value within a torque range that can be output by the driving and braking force systems in vehicle control system 1.

That is, when requested driving and braking torque Ttg output by first multiplication unit 104 exceeds an upper limit Ttgmax, limiter control unit 108 outputs upper limit Ttgmax as requested driving and braking torque Ttg.

When requested driving and braking torque Ttg output by first multiplication unit 104 is equal to or less than upper limit Ttgmax, limiter control unit 108 outputs requested driving and braking torque Ttg output by first multiplication unit 104 as is.

Limiter control unit 108 outputs a signal indicating requested driving and braking torque Ttg, which has been limited to be equal to or less than upper limit Ttgmax, to a third multiplication unit 109 as a requested driving and braking torque TtgF applied to front wheels 11 and 12, and outputs the signal indicating requested driving and braking torque Ttg as a requested driving and braking torque TtgR applied to rear wheels 13 and 14 to a front-rear distribution ratio control unit 110.

Third multiplication unit 109 multiplies the signal indicating requested driving and braking torque Ttg acquired from limiter control unit 108 by a fixed value, which is −1, so as to invert the sign of requested driving and braking torque Ttg from positive “+” to negative “−”.

Herein, positive requested driving and braking torque Ttg represents a driving torque request, and negative requested driving and braking torque Ttg represents a braking torque request.

Thus, the process executed by third multiplication unit 109 to multiply the signal indicating requested driving and braking torque Ttg by −1 is a process of setting requested driving and braking torque TtgF applied to front wheels 11 and 12 to a braking request.

On the other hand, because requested driving and braking torque TtgR applied to rear wheels 13 and 14 is sent to front-rear distribution ratio control unit 110 without changing the sign of the output of limiter control unit 108, requested driving and braking torque TtgR is positive requested driving and braking torque Ttg, that is, a driving torque request.

Front-rear distribution ratio control unit 110 acquires the signals indicating negative requested driving and braking torque TtgF, positive requested driving and braking torque TtgR, and a driver-requested torque, and executes front-rear distribution of the driving and braking torque based on the driver-requested torque, which will be described below.

Next, front-rear distribution ratio control unit 110 outputs a braking torque command based on requested driving and braking torque TtgF that has been obtained after the distribution control to front motor 71, and causes front motor 71 to generate regenerative torque (in other words, braking torque).

In addition, front-rear distribution ratio control unit 110 outputs a driving torque command based on requested driving and braking torque TtgR that has been obtained after the distribution control to rear motor 73, and causes rear motor 73 to generate motor torque (in other words, driving torque).

In this operation, basically, front-rear distribution ratio control unit 110 sets a front-rear distribution ratio, which is 50:50, at which the magnitude of the driving and braking force applied to front wheels 11 and 12 is the same as the magnitude of the driving and braking force applied to rear wheels 13 and 14, such that vehicle 10 does not accelerate or decelerate. In this way, the driving and braking forces applied to the front and rear wheels by the turning control are balanced out.

That is, the braking torque corresponding to requested driving and braking torque Ttg output by limiter control unit 108 is applied to front wheels 11 and 12, and the driving torque corresponding to requested driving and braking torque Ttg output by limiter control unit 108 is applied to rear wheels 13 and 14.

In this way, even when the turning control is executed, occurrence of acceleration/deceleration not intended by the driver is prevented.

Alternatively, front-rear distribution ratio control unit 110 sets the front-rear distribution ratio to a predetermined distribution ratio other than the basic ratio of 50:50, depending on the acceleration/deceleration state of vehicle 10.

When vehicle 10 accelerates, front-rear distribution ratio control unit 110 sets the distribution ratio between the magnitude of the braking force applied to front wheels 11 and 12 and the magnitude of the driving force applied to rear wheels 13 and 14 to 40:60, for example.

That is, front-rear distribution ratio control unit 110 decreases the magnitude of the braking force applied to front wheels 11 and 12 to a value less than that set when the front-rear distribution ratio is the basic value of 50:50, and relatively increases the magnitude of the driving force applied to rear wheels 13 and 14 to a value greater than that set when the front-rear distribution ratio is the basic value of 50:50.

For example, when vehicle 10 accelerates and when the driving torque generated by rear motor 73 by the execution of the turning control may exceed the limit, front-rear distribution ratio control unit 110 sets a distribution ratio such that the braking force applied to front wheels 11 and 12 is relatively less in the turning control.

In this way, the driving force applied to rear wheels 13 and 14 is reduced to balance out the braking force applied to front wheels 11 and 12. Accordingly, because the driving force that can be generated by rear motor 73 for the acceleration can be increased, the driver's acceleration request can be satisfied with a motor torque within the limit.

When vehicle 10 decelerates, front-rear distribution ratio control unit 110 sets the distribution ratio between the magnitude of the braking force applied to front wheels 11 and 12 and the magnitude of the driving force applied to rear wheels 13 and 14 to 60:40, for example.

That is, front-rear distribution ratio control unit 110 increases the magnitude of the braking force applied to front wheels 11 and 12 to a value greater than that set when the front-rear distribution ratio is the basic value of 50:50, and relatively decreases the magnitude of the driving force to rear wheels 13 and 14 to a value less than that set when the front-rear distribution ratio is the basic value of 50:50.

For example, when vehicle 10 decelerates and when the regenerative torque generated by front motor 71 by the execution of the turning control may exceed the limit, front-rear distribution ratio control unit 110 sets a distribution ratio such that the driving force applied to rear wheels 13 and 14 is relatively less in the turning control.

In this way, the braking force applied to front wheels 11 and 12 is reduced to balance out the driving force applied to rear wheels 13 and 14. Accordingly, because the braking force (in other words, regenerative torque) that can be generated by front motor 71 for the deceleration can be increased, the driver's deceleration request can be satisfied with a regenerative torque within the limit.

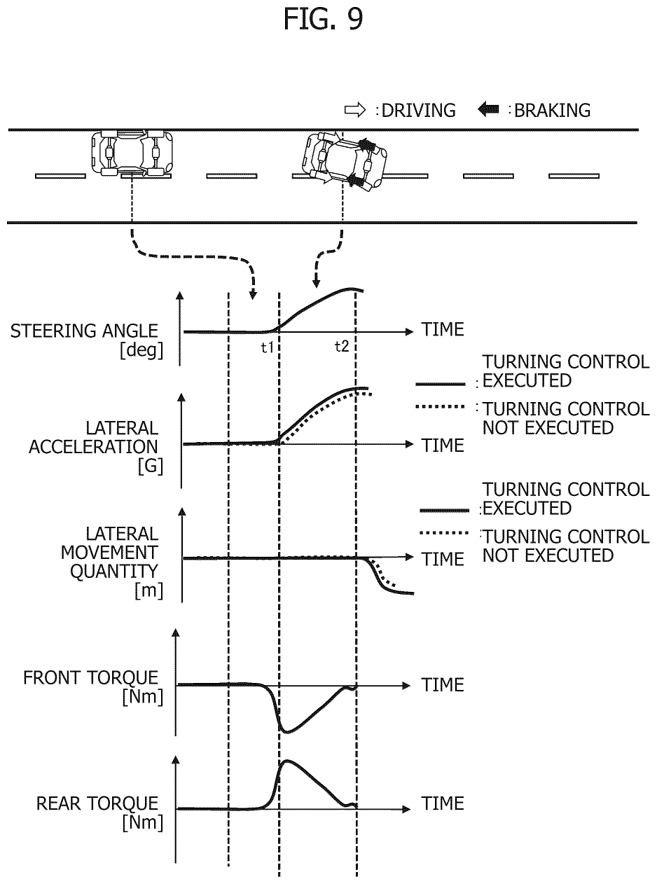

FIG. 9 illustrates change in vehicle state when the turning control in which braking force is applied to front wheels 11 and 12 and driving force is applied to rear wheels 13 and 14 is executed.

FIG. 9 illustrates change in steering angle θ [deg], lateral acceleration [G], lateral movement quantity [m], driving and braking torque [Nm] applied to front wheels 11 and 12, and driving and braking torque [Nm] applied to rear wheels 13 and 14 when vehicle 10 changes its lane from the left lane to the right lane while running on a road with two lanes in each direction.

To start the lane change (in other words, turning), at time t1, the driver starts to rotate steering wheel 51 from the neutral position in the right direction.

At this timing, vehicle control unit 31 determines this steering operation (that is, the primary steering) based on the change in steering angle θ, increases requested driving and braking torque Ttg, and outputs a control command to the front driving and braking apparatus and the rear driving and braking apparatus such that braking torque is applied to front wheels 11 and 12 and driving torque is applied to rear wheels 13 and 14.

Because this driving and braking control increases the lateral acceleration of vehicle 10, the lateral movement quantity of vehicle 10 increases, and the turning performance is consequently improved.

In addition, because the braking torque applied to front wheels 11 and 12 and the driving torque applied to rear wheels 13 and 14 are balanced out, occurrence of the acceleration/deceleration not intended by the driver is prevented.

### SECOND EXAMPLE

Hereinafter, turning control according to a second example will be described.

In the second example, vehicle control unit 31 determines the primary steering, which is the state in which steering wheel 51 is rotated from its neutral position in one of the right and left directions, and determines secondary steering, which is a state in which steering wheel 51 is rotated in the other direction after the primary steering.

At the primary steering, vehicle control unit 31 applies braking force to front wheels 11 and 12 and applies driving force to rear wheels 13 and 14. When the steering operation switches to the secondary steering, vehicle control unit 31 applies driving force to front wheels 11 and 12 and applies braking force to rear wheels 13 and 14.

That is, at the primary steering, vehicle control unit 31 calculates first braking force generated by the front driving and braking apparatus and first driving force generated by the rear driving and braking apparatus, based on the speed of vehicle 10 and the physical quantities relating to steering angle θ, and outputs a first control command for generating the first braking force and the first driving force.

In addition, at the secondary steering after the primary steering, vehicle control unit 31 calculates second driving force generated by the front driving and braking apparatus and second braking force generated by the rear driving and braking apparatus, based on the speed of vehicle 10 and the physical quantities relating to steering angle θ, and outputs a second control command for generating the second driving force and the second braking force.

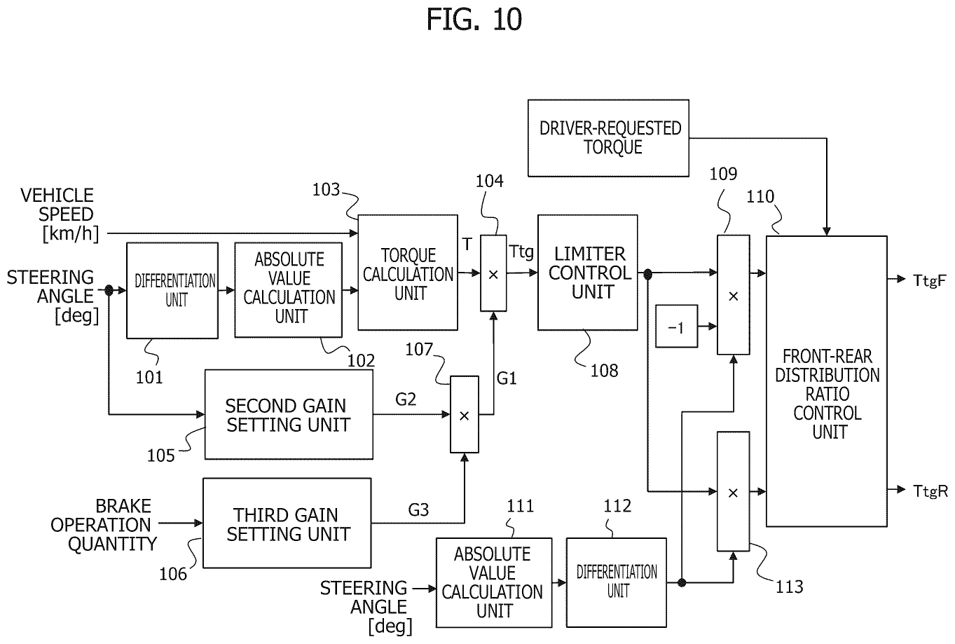

FIG. 10 is a block diagram illustrating functional units of vehicle control unit 31 for the turning control according to the second example.

In FIG. 10, the same blocks as those in FIG. 3 are denoted by the same reference characters, and detailed description thereof will be omitted.

The vehicle control unit 31 according to the second example includes an absolute value calculation unit 111, a differentiation unit 112, and a fourth multiplication unit 113, in addition to the functional units illustrated in FIG. 3.

Absolute value calculation unit 111 calculates absolute value |θ| of steering angle θ.

Differentiation unit 112 calculates steering angular velocity Δ|θ| by differentiating absolute value |θ| of steering angle θ with respect to time. When a signal indicating the sign of steering angular velocity Δ|θ|, that is, absolute value |θ| of steering angle θ, increases and when steering angular velocity Δ|θ| represents positive, differentiation unit 112 outputs a signal indicating +1. When absolute value |θ| of steering angle θ decreases and when steering angular velocity Δ|θ| represents negative, differentiation unit 112 outputs a signal indicating −1.

That is, at the primary steering, which is the state in which steering wheel 51 is rotated from its neutral position in one of the right and left directions, differentiation unit 112 outputs a signal indicating +1. At the secondary steering, which is the state in which steering wheel 51 is rotated in the other direction after the primary steering, differentiation unit 112 outputs a signal indicating −1.

Thus, the output signal of differentiation unit 112 indicates a determination result indicating the primary steering or the secondary steering.

Third multiplication unit 109 multiplies the signal indicating requested driving and braking torque Ttg acquired from limiter control unit 108 by the fixed value of −1, as described above. In addition, third multiplication unit 109 multiplies the resultant product by the output signal (−1 or +1) of differentiation unit 112, and outputs the final product as requested driving and braking torque TtgF applied to front wheels 11 and 12.

Fourth multiplication unit 113 multiplies the signal indicating requested driving and braking torque Ttg acquired from limiter control unit 108 by the output signal (−1 or +1) of differentiation unit 112, and outputs the resultant product as requested driving and braking torque TtgR applied to rear wheels 13 and 14.

At the primary steering, that is, when the output signal of differentiation unit 112 represents +1, third multiplication unit 109 outputs a negative value indicating a braking request, as requested driving and braking torque TtgF applied to front wheels 11 and 12, and fourth multiplication unit 113 outputs a positive value indicating a drive request as requested driving and braking torque TtgR applied to rear wheels 13 and 14.

On the other hand, at the secondary steering, that is, when the output signal of differentiation unit 112 represents −1, third multiplication unit 109 outputs a positive value indicating a driving request as requested driving and braking torque TtgF applied to front wheels 11 and 12, and fourth multiplication unit 113 outputs a negative value indicating a braking request as requested driving and braking torque TtgR applied to rear wheels 13 and 14.

That is, at the primary steering, the signs of requested driving and braking torques TtgF and TtgR are set such that braking force is applied to front wheels 11 and 12 and driving force is applied to rear wheels 13 and 14. At the secondary steering after the primary steering, the signs of requested driving and braking torques TtgF and TtgR are set such that driving force is applied to front wheels 11 and 12 and braking force is applied to rear wheels 13 and 14.

Thus, although braking force is applied to front wheels 11 and 12 and driving force is applied to rear wheels 13 and 14 at the primary steering, when the steering operation switches from the primary steering to the secondary steering, the driving and braking forces applied to the front and rear wheels are inverted, that is, driving force is applied to front wheels 11 and 12 and braking force is applied to rear wheels 13 and 14.

According to this second example, at the primary steering, the lateral acceleration (in other words, the lateral movement quantity) increases, and the turning performance of vehicle 10 improves. In addition, at the secondary steering, the stability performance of vehicle 10 can be improved by promptly reducing the lateral acceleration.

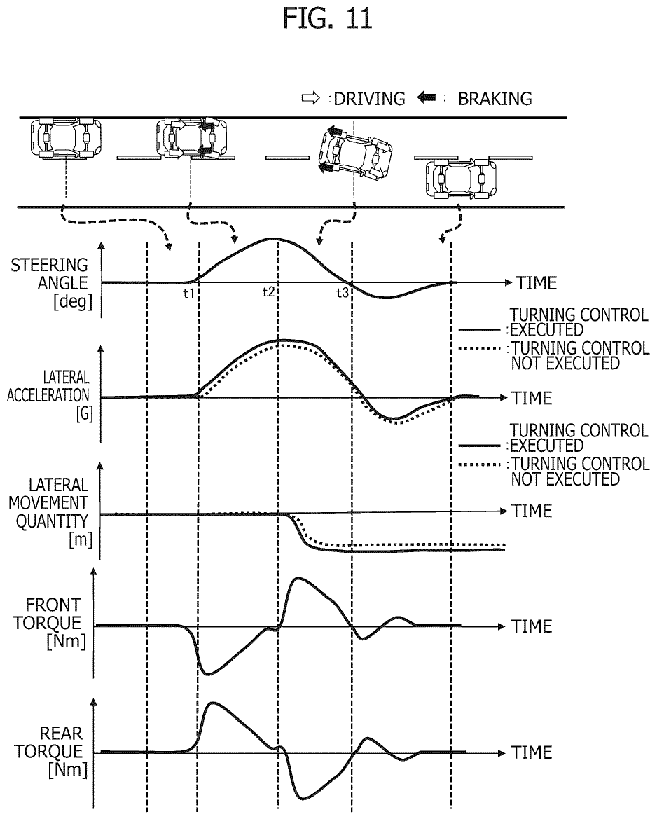

FIG. 11 illustrates change in vehicle state according to the second example in which braking force is applied to front wheels 11 and 12 and driving force is applied to rear wheels 13 and 14 at the primary steering and in which driving force is applied to front wheels 11 and 12 and braking force is applied to rear wheels 13 and 14 at the secondary steering.

In FIG. 11, to execute lane change (in other words, turning), at time t1, the driver starts to rotate steering wheel 51 from the neutral position in the right direction. At time t2, the driver starts to rotate steering wheel 51 in the opposite direction back to the neutral position.

At the primary steering, that is, when absolute value |θ| of steering angle θ increases from time t1 to time t2, because braking force is applied to front wheels 11 and 12 and driving force is applied to rear wheels 13 and 14, the lateral acceleration (lateral movement quantity) of vehicle 10 increases, and the turning performance of vehicle 10 consequently improves.

Next, at the secondary steering, that is, when steering wheel 51 is returned to the neutral position from time t2 to time t3 (in other words, when the lane change ends or when the vehicle exits a curve), because driving force is applied to front wheels 11 and 12 and braking force is applied to rear wheels 13 and 14, the lateral acceleration of vehicle 10 converges quickly, and therefore, the stability performance of vehicle 10 improves.

### THIRD EXAMPLE Hereinafter, turning control according to a third example will be described.

In the third example, even after steering wheel 51 is rotated back to a position around the neutral position, the state in which driving force is applied to front wheels 11 and 12 and braking force is applied to rear wheels 13 and 14, that is, the determination of the secondary steering, is continued. In this way, the stability performance of vehicle 10 can be further improved.

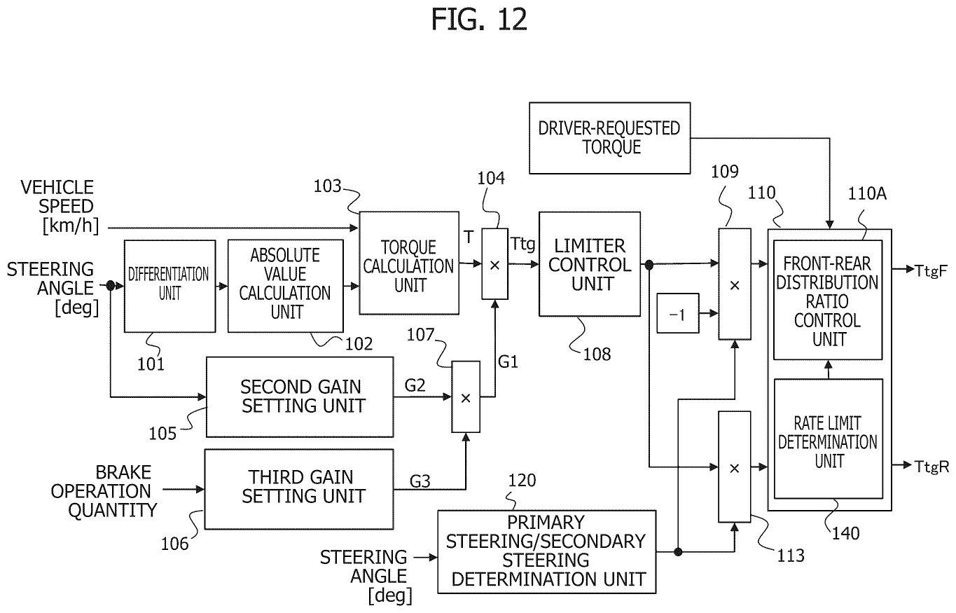

FIG. 12 is a block diagram illustrating functional units of vehicle control unit 31 for the turning control according to the third example.

In FIG. 12, the same blocks as those in FIG. 3 or FIG. 10 are denoted by the same reference characters, and detailed description thereof will be omitted.

Vehicle control unit 31 according to the third example includes a primary steering/secondary steering determination unit 120, instead of absolute value calculation unit 111 and differentiation unit 112 illustrated in FIG. 10.

In addition, front-rear distribution ratio control unit 110 of vehicle control unit 31 according to the third example includes a front-rear distribution ratio control unit 110A having the same function as that of front-rear distribution ratio control unit 110 according to the first example, and includes a rate limit determination unit 140.

Third multiplication unit 109 and fourth multiplication unit 113 switch the signs of requested driving and braking torques TtgF and TtgR, based on a primary steering/secondary steering determination signal output by primary steering/secondary steering determination unit 120, and switch a driving request and a braking request.

As in the second example, primary steering/secondary steering determination unit 120 basically determines the primary steering or the secondary steering, based on the sign of derivative value Δ|θ|.

However, even after steering wheel 51 is rotated back and steering angle θ returns back to the angle of a position around the neutral position and negative derivative value Δ|θ| is inverted to positive derivative value Δ|θ|, primary steering/secondary steering determination unit 120 continues the determination of the secondary steering, which has been used when steering wheel 51 is rotated back.

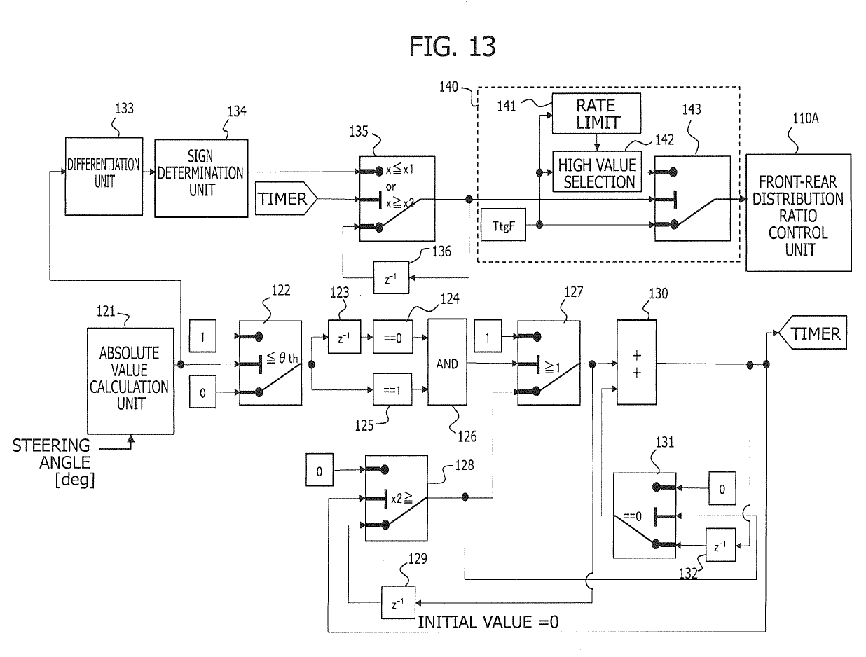

FIG. 13 is a block diagram illustrating details of primary steering/secondary steering determination unit 120 and rate limit determination unit 140.

An absolute value calculation unit 121 calculates absolute value |θ| of steering angle θ. A first switch unit 122 compares absolute value |θ| of steering angle θ with a steering angle threshold θth (θth>0), which is a value near the neutral position.

When absolute value |θ| of steering angle θ is equal to or less than steering angle threshold θth, that is, when steering angle θ falls within a predetermined range including the neutral position, first switch unit 122 outputs 1. When absolute value |θ| of steering angle θ exceeds steering angle threshold θth, that is, when steering angle θ does not indicate a position around the neutral position, first switch unit 122 outputs 0.

A delay unit 123 holds the previous output value of first switch unit 122.

A first comparison calculation unit 124 compares the output of delay unit 123 (that is, the previous output value of first switch unit 122) with 0. When the output of delay unit 123 is 0, first comparison calculation unit 124 outputs 1.

In addition, a second comparison calculation unit 125 compares the output of first switch unit 122 (that is, the current value) with 1. When the output of first switch unit 122 is 1, second comparison calculation unit 125 outputs 1.

A logical AND operation unit 126 calculates the logical AND of the output of first comparison calculation unit 124 and the output of second comparison calculation unit 125.

When steering angle θ returns to the angle of a position around the neutral position, the position being defined by steering angle threshold θth, from the angle of a position farther away from the neutral position, the output of first switch unit 122 is switched from 0 to 1. In this case, the output of first comparison calculation unit 124 and the output of second comparison calculation unit 125 both represent 1, and therefore, logical AND operation unit 126 outputs 1.

A second switch unit 127 outputs 1 when the output of logical AND operation unit 126 is equal to or greater than 1 (that is, when the output of logical AND operation unit 126 is 1). Second switch unit 127 outputs the output of a third switch unit 128, which will be described below, when the output of logical AND operation unit 126 is less than 1 (that is, when the output of logical AND operation unit 126 is 0).

Third switch unit 128 outputs 0 when a timer x output by an addition unit 130, which will be described below, reaches a second threshold x2 or greater. When timer x is less than second threshold x2, third switch unit 128 outputs the previous output value of second switch unit 127 held by a delay unit 129.

In this example, the initial value of delay unit 129 is 0.

Thus, while the output of logical AND operation unit 126 is 0, the output of third switch unit 128 is also 0, and the output of second switch unit 127 is held at 0.

When the output of logical AND operation unit 126 is switched to 1, the output of second switch unit 127 is switched to 1. When the output of logical AND operation unit 126 is returned to 0 next time, because the output of delay unit 129 holds the previous value 1, the output of second switch unit 127 continuously holds 1.

That is, when steering angle θ returns to the angle of a position around the neutral position, the position being defined by steering angle threshold θth, from the angle of a position farther away from the neutral position, second switch unit 127 switches from the state in which it outputs 0 to the state in which it outputs 1.

The output of second switch unit 127 is given to addition unit 130 as a value for addition.

Addition unit 130 adds the output of second switch unit 127 to the output of a fourth switch unit 131, and outputs the resultant sum as timer x.

Fourth switch unit 131 resets its output to 0 when the output of third switch unit 128 is 0. However, while the output of third switch unit 128 is 1, fourth switch unit 131 outputs the previous output value of addition unit 130 (in other words, the previous value of timer x) held by a delay unit 132.

That is, when steering angle θ returns to the angle of a position around the neutral position, the position being defined by steering angle threshold θth, from the angle of a position farther away from the neutral position and when the output of second switch unit 127 represents 1, timer x, which is the output of addition unit 130, is incremented by 1.

Next, when timer x reaches second threshold x2 or greater, the output of third switch unit 128 represents 0, and the output of fourth switch unit 131 also represents 0. As a result, timer x is reset to 0.

A differentiation unit 133 acquires absolute value |θ| of steering angle θ calculated by absolute value calculation unit 121, and calculates steering angular velocity Δ|θ| by differentiating absolute value |θ| with respect to time.

Based on the determination of the sign of steering angular velocity A|θ|, a sign determination unit 134 determines whether the steering operation is the primary steering at which braking force is applied to front wheels 11 and 12 and driving force is applied to rear wheels 13 and 14 or the secondary steering at which driving force is applied to front wheels 11 and 12 and braking force is applied to rear wheels 13 and 14.

That is, when steering angle |θ| increases, that is, when steering angle θ changes to an angle away from the angle of the neutral position and when steering angular velocity Δ|θ| is positive, sign determination unit 134 determines that the steering state is the primary steering state in which braking force is applied to front wheels 11 and 12 and driving force is applied to rear wheels 13 and 14, and outputs a signal indicating +1.

On the other hand, when steering angle |θ| decreases, that is, when steering angle θ changes to an angle near the angle of the neutral position and when steering angular velocity Δ|θ| is negative, sign determination unit 134 determines the steering state is the secondary steering state in which driving force is applied to front wheels 11 and 12 and braking force is applied to rear wheels 13 and 14, and outputs a signal indicating −1.

A fifth switch unit 135 is a functional unit that compares timer x with thresholds x1 and x2 (x2>x1≥0) and switches its output (that is, a signal indicating the determination of the primary steering or the secondary steering) depending on the comparison result.

When timer x is equal to or less than first threshold x1 (x≤x1) or when timer x is equal to or greater than second threshold x2 (x≥x2), fifth switch unit 135 outputs the output of sign determination unit 134 (that is, the signal indicating the determination of the primary steering or the secondary steering).

On the other hand, as long as timer x satisfies the relationship x1<x<x2, fifth switch unit 135 uses the previous output value of fifth switch unit 135 held by delay unit 136 as the current output value.

For example, when the driver starts to change lane and rotates steering wheel 51 in either the right or left direction from the neutral position, steering angular velocity Δ|θ| is positive, and the steering state is set to the primary steering state in which front braking force is applied to wheels 11 and 12 and driving force is applied to rear wheels 13 and 14.

After certain steering angle θ is reached, the driver starts to rotate steering wheel 51 back to the neutral position. As a result, steering angular velocity Δ|θ| represents negative, and the primary steering state switches to the secondary steering state in which driving force is applied to front wheels 11 and 12 and braking force is applied to rear wheels 13 and 14.

When steering wheel 51 is rotated back to a position around the neutral position and is rotated continuously in the opposite direction from the neutral position, steering angular velocity Δ|θ| is switched to positive.

Thus, sign determination unit 134 determines that the steering is the primary steering in which braking force is applied to front wheels 11 and 12 and driving force is applied to rear wheels 13 and 14.

When steering wheel 51 returns to a position around the neutral position (specifically, steering angle θ reaches a predetermined steering angle immediately before the neutral position), timer x starts a count-up operation.

Because steering angular velocity Δ|θ| is negative at the start of this count-up operation, the state determined by sign determination unit 134 is the secondary steering.

Thus, while timer x satisfies the relationship x1<x<x2, that is, for a predetermined time after steering wheel 51 is returned to a position around the neutral position, fifth switch unit 135 continuously outputs the determination of the secondary steering made at the start of the count-up operation of timer x.

In this way, when steering wheel 51 is returned to a position around the neutral position and is continuously rotated in the opposite direction from the neutral position, even when steering angular velocity Δ|θ| changes from negative to positive as steering wheel 51 passes through the neutral position (in other words, even when the determination of sign determination unit 134 is inverted from the secondary steering to the primary steering), the output of fifth switch unit 135 is held at the signal of −1 indicating the secondary steering, and the application of the driving force to front wheels 11 and 12 is continued.

If there is no function for maintaining the determination of the secondary steering with timer x, when steering angular velocity Δ|θ| is inverted from negative to positive, the output of sign determination unit 134 is switched from the determination of the secondary steering to the determination of the primary steering. That is, the control for improving the stability through the application of driving force to front wheels 11 and 12 is switched to the control for improving the turning performance through the application of braking force to front wheels 11 and 12.

However, when steering wheel 51 is rotated to a position around the neutral position and is further rotated in the opposite direction from the neutral position is when a turn such as for lane change is ended, and therefore, improving the stability needs to be prioritized over improving the turning performance.

Thus, when steering wheel 51 is rotated to a position around the neutral position and is further rotated in the opposite direction from the neutral position, the stability of vehicle 10 at the end of the lane change (in other words, turning) is improved by continuing the determination of the secondary steering.

When steering angle θ passes through the angle of the neutral position, requested driving and braking torque Ttg output by limiter control unit 108 first decreases to zero and then increases again because of second gain G2 based on steering angle θ.

Thus, even when the determination of the secondary steering is continued when steering angle θ passes through the angle of the neutral position, the driving force applied to front wheels 11 and 12 and the braking force applied to rear wheels 13 and 14 increase again after decreasing around the neutral position. That is, the effect obtained by continuing the determination of the secondary steering cannot be fully obtained.

Thus, vehicle control unit 31 includes a rate limit determination unit 140 as a functional unit that ensures the driving and braking forces applied to the front and rear wheels when the determination of the secondary steering is continued.

Rate limit determination unit 140 includes a rate limit process unit 141, a high-value selection unit 142, and a sixth switch unit 143.

Rate limit process unit 141 acquires a signal indicating requested driving and braking torque TtgF applied to front wheels 11 and 12 from third multiplication unit 109, executes a rate limit process for limiting change in requested driving and braking torque TtgF, and outputs a signal obtained after the rate limit process (that is, a limited driving and braking force value) as a requested driving and braking torque TtgFRL.

For example, when requested driving and braking torque TtgF decreases, rate limit process unit 141 outputs requested driving and braking torque TtgFRL of which the decrease delays compared with requested driving and braking torque TtgF.

High-value selection unit 142 outputs the greater one of requested driving and braking torque TtgFRL, which is obtained after the rate limit process and is output by rate limit process unit 141, and requested driving and braking torque TtgF output by third multiplication unit 109, as requested driving and braking torque TtgF.

Thus, when requested driving and braking torque TtgF decreases, high-value selection unit 142 selects requested driving and braking torque TtgFRL, which represents a value greater than requested driving and braking torque TtgF output by third multiplication unit 109.

Based on the primary steering/secondary steering determination signal, which has been output by primary steering/secondary steering determination unit 120 (fifth switch unit 135), sixth switch unit 143 outputs one of the output of high-value selection unit 142 and the output of third multiplication unit 109, as requested driving and braking torque TtgF applied to front wheels 11 and 12.

Specifically, when the output of primary steering/secondary steering determination unit 120 (fifth switch unit 135) is −1, representing the secondary steering, sixth switch unit 143 selects and outputs the output of high-value selection unit 142.

On the other hand, when the output of primary steering/secondary steering determination unit 120 (fifth switch unit 135) is +1 representing the primary steering, sixth switch unit 143 outputs the output of third multiplication unit 109 as requested driving and braking torque TtgF.

Requested driving and braking torque TtgR applied to rear wheels 13 and 14 is set as a signal of which the absolute value is the same as that of requested driving and braking torque TtgF output by sixth switch unit 143 and of which the sign is inverted.

In addition, as described above, requested driving and braking torques TtgF and TtgR set by the process in rate limit determination unit 140 are processed by front-rear distribution ratio control unit 110A, and finally, the driving and braking torques applied to the front and rear wheels are determined.

When steering wheel 51 is rotated to a position around the neutral position and is further rotated in the opposite direction from the neutral position, primary steering/secondary steering determination unit 120 continues the determination of the secondary steering.

However, in this case, requested driving and braking torque TtgF that has not been processed in rate limit determination unit 140 first decreases to 0 when steering angle θ crosses the angle of the neutral position, and next increases again.

Thus, during the determination of the secondary steering, if the driving and braking forces applied to the front and rear wheels are controlled without executing the process in rate limit determination unit 140, the effect of improving the stability of vehicle 10 (that is, the effect of obtaining prompt convergence of the lateral acceleration) cannot be stably obtained. In contrast, because the output of high-value selection unit 142 gradually decreases before and after steering angle θ crosses the angle of the neutral position, by applying the driving and braking forces to the front and rear wheels based on the output of high-value selection unit 142 during the determination of the secondary steering, the effect of improving the stability of vehicle 10 (the effect of obtaining prompt convergence of the lateral acceleration) can be obtained stably.

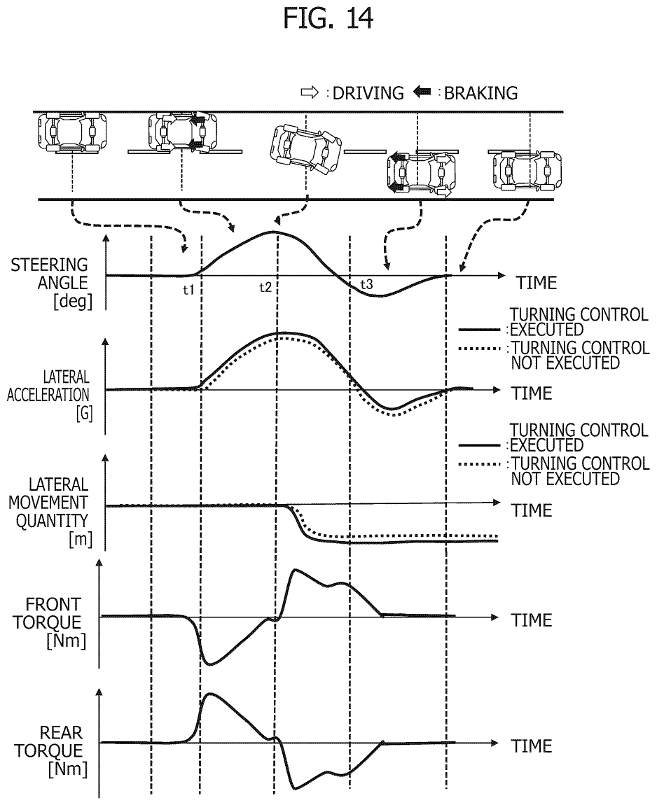

FIG. 14 illustrates change in steering angle θ, lateral acceleration, lateral movement quantity, driving and braking torque applied to front wheels 11 and 12, and driving and braking torque applied to rear wheels 13 and 14 when vehicle 10 changes the lane and the turning control is executed with the configuration illustrated by the block diagrams in FIG. 12 and FIG. 13.

At time t1, steering wheel 51 is rotated from the neutral position, and the lane change is started.

In the primary steering state, which is the period from time t1 to time t2, steering angle e changes from the angle of the neutral position to the angle of a position away from the neutral position, and in this period, vehicle control unit 31 applies braking torque to front wheels 11 and 12 and driving force to rear wheels 13 and 14.

In this driving and braking control state, the lateral acceleration increases, and the turning performance improves.

From time t2, an operation of rotating steering wheel 51 back to the neutral position is executed.

In this operation, based on the determination of the secondary steering, vehicle control unit 31 applies driving torque to front wheels 11 and 12 and applies braking torque to rear wheels 13 and 14.

Although steering angle θ returns to the angle around the neutral position at time t3, steering angle θ passes through the angle of the neutral position and changes in the opposite direction.

After time t3, although steering angle θ continues to change in the opposite direction from the angle of the neutral position, vehicle control unit 31 continues the control (that is, the determination of the secondary steering) in which the driving torque is applied to front wheels 11 and 12 and the braking torque is applied to rear wheels 13 and 14.

In this example, when steering angle θ crosses the angle of the neutral position, because the above-described function of rate limit determination unit 140 prevents the driving and braking forces applied to the front and rear wheels from decreasing, the effect of improving the stability by the continuous determination of the secondary steering can be improved as much as possible.

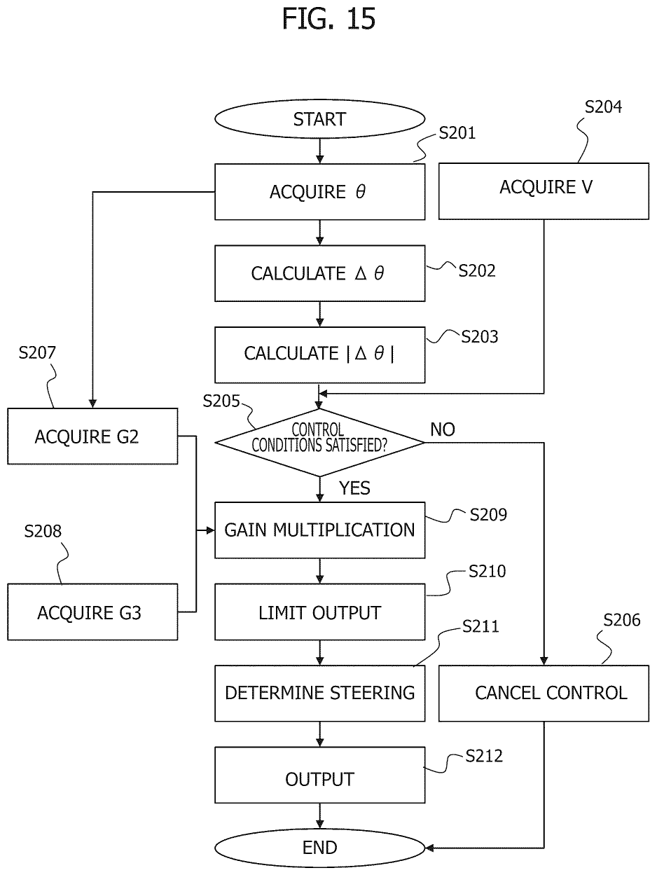

The flowchart in FIG. 15 illustrates a turning control process in which driving and braking torques are applied to the front and rear wheels based on the determination of the primary steering/secondary steering common to the second example and the third example.

Vehicle control unit 31 acquires information about steering angle θ in step S201, calculates steering angular velocity Δθ by differentiating steering angle θ in step S202, and obtains absolute value |Δθ| of steering angular velocity Δθ in step S203.

Next, in step S204, vehicle control unit 31 acquires information about vehicle speed V. Next, in step S205, vehicle control unit 31 determines whether absolute value |Δθ| of steering angular velocity Δθ and vehicle speed V satisfy their respective turning control execution conditions, in other words, whether 0 is set as driving and braking torque T corresponding to current absolute value |Δθ| of steering angular velocity Δθ and current vehicle speed V.

If absolute value |Δθ| of steering angular velocity Δθ0 and vehicle speed V do not satisfy their respective turning control execution conditions (in other words, if driving and braking torque T is 0), vehicle control unit 31 determines not to execute the turning control, that is, not to execute application of driving and braking forces to front wheels 11 and 12 and rear wheels 13 and 14, in Step S206.

On the other hand, if absolute value |Δθ| of steering angular velocity Δθ0 and vehicle speed V satisfy their respective turning control execution conditions (in other words, if driving and braking torque T is not 0), vehicle control unit 31 proceeds to step S209.

In step S209, vehicle control unit 31 calculates requested driving and braking torque Ttg by multiplying torque T corresponding to current absolute value |Δθ| of steering angular velocity Δθ and current vehicle speed V by gains G2 and G3 (Ttg=T×G2×G3).

Vehicle control unit 31 sets second gain G2 based on steering angle θ in step S207, and sets third gain G3 based on the brake operation quantity in step S208.

Next, in step S209, vehicle control unit 31 calculates requested driving and braking torque Ttg by using gains G2 and G3.

Next, in step S210, vehicle control unit 31 manages requested driving and braking torque Ttg such that requested driving and braking torque Ttg does not exceed the upper limit in vehicle control system 1.

Next, in step S211, vehicle control unit 31 determines whether the steering is the primary steering or the secondary steering, based on absolute value |θ| of steering angle θ, derivative value Δ|θ|, etc. In other words, vehicle control unit 31 determines whether to apply braking force to front wheels 11 and 12 and driving force to rear wheels 13 and 14 or to apply driving force to front wheels 11 and 12 and braking force to rear wheels 13 and 14.

Next, in step S212, vehicle control unit 31 outputs a control command for applying the driving and braking forces to the front and rear wheels, based on the determination of the primary steering or the secondary steering and based on the calculation result of requested driving and braking torque Ttg.

At the primary steering, which is the state in which steering wheel 51 is rotated from the neutral position in one of the right or left directions (in other words, the steering angle increases), vehicle control unit 31 applies braking force to front wheels 11 and 12 and applies driving force to rear wheels 13 and 14 based on requested driving and braking torque Ttg.

On the other hand, at the secondary steering, which is the state in which steering wheel 51 is rotated in the opposite direction (in other words, the steering angle decreases) after the primary steering, vehicle control unit 31 applies driving force to front wheels 11 and 12 and applies braking force to rear wheels 13 and 14 based on requested driving and braking torque Ttg.

When steering wheel 51 is rotated back to the neutral position and is further rotated beyond the neutral position in the opposite direction, vehicle control unit 31 according to the third example continues the determination of the secondary steering and continues the control for applying driving force to front wheels 11 and 12 and braking force to rear wheels 13 and 14 before and after the neutral position.

In the torque map illustrated in FIG. 4, as described above, first threshold THV1, which is the turning control execution condition for vehicle speed V, can be set to 40 km/h, and first threshold THθ1, which is the turning control execution condition for absolute value |Δθ| of steering angular velocity Δθ, can be set to 50 deg/s.

In this case, when steering wheel 51 is rotated by 60 deg/s while vehicle 10 is running at 60 km/h, vehicle control unit 31 executes a control step for applying braking force to front wheels 11 and 12 and applying driving force to rear wheels 13 and 14.

That is, applying braking force to front wheels 11 and 12 and driving force to rear wheels 13 and 14 when steering wheel 51 is rotated by 60 deg/s while vehicle 10 is running at 60 km/h corresponds to implementation of the present invention.

In addition, when steering wheel 51 is rotated by 70 deg/s, vehicle control unit 31 executes a control step for setting greater braking force applied to front wheels 11 and 12 and greater driving force applied to rear wheels 13 and 14 than those applied when the steering wheel is rotated by 60 deg/s.

That is, applying greater braking force applied to front wheels 11 and 12 and greater driving force applied to rear wheels 13 and 14 when steering wheel 51 is rotated by 70 deg/s than those when steering wheel 51 is rotated by 60 deg/s means execution of a control step for applying greater driving and braking forces to the front and rear wheels as the steering angular velocity increases at least between 60 deg/s and 70 deg/s.

In addition, while vehicle 10 is running at 60 km/h, when steering wheel 51 is first rotated clockwise at 60 deg/s and is next rotated counterclockwise at 60 deg/s, vehicle control unit 31 executes a control step for applying driving force to front wheels 11 and 12 and applying braking force to rear wheels 13 and 14.

That is, setting driving force to front wheels 11 and 12 and braking force to rear wheels 13 and 14 applied when steering wheel 51 is first rotated clockwise at 60 deg/s and is next rotated counterclockwise at 60 deg/s while vehicle 10 is running at 60 km/h corresponds implementation of the present invention.

The individual technical concepts described in the above-described examples can be appropriately combined and used, as long as there is no conflict.

Although the present invention has thus been described in detail with reference to preferred examples, it will be apparent to those skilled in the art that various kinds of modified modes are possible, based on the basic technical concepts and teachings of the present invention.

For example, at least one of the driving force actuator that applies driving force to front wheels 11 and 12 and the driving force actuator that applies driving force to rear wheels 13 and 14 may be an internal-combustion engine.

In addition, the braking force applied to the road wheels for the turning control may be friction braking force based on brake actuator 15, 16, 17, and 18, instead of regenerative braking force based on a motor.

However, using regenerative braking in the turning control achieves better improvement in responsiveness and control performance, compared with the case in which friction braking is used.

In addition, in the third example, although vehicle control unit 31 defines the period of time in which the determination of the secondary steering is continued, based on the time that elapses from the time steering angle θ has returned to the angle of a position around the neutral position, the determination of the continuation can be cancelled before the set time is reached, based on steering angle θ, steering angular velocity Δθ, etc.

For example, when the absolute value of steering angle θ exceeds a set time or when the steering angular velocity in a direction away from the neutral position exceeds a set time while the determination of the secondary steering is continued, vehicle control unit 31 may switch the determination of the secondary steering to the determination of the primary steering.

In addition, when setting third gain G3 based on brake operation quantity, vehicle control unit 31 may set third gain G3 to 1.0 when the brake operation quantity is equal to or less than a set value, and may set third gain G3 to 0 when the brake operation quantity exceeds the set value.

That is, by comparing the brake operation quantity with a set value, vehicle control unit 31 can switch ON and OFF of the turning control (in other words, execution and non-execution of the turning control).

In addition, in an emergency avoidance mode executed, for example, when vehicle 10 avoids an obstacle, vehicle control unit 31 may execute the turning control according to the first example. In a mode other than the emergency avoidance mode, vehicle control unit 31 may execute the turning control in which the driving and braking are inverted based on the determination of the primary steering or the secondary steering according to the second example or the third example.

This is because the emergency avoidance mode needs the turning performance more than the stability performance.

In addition, in the above-described examples, although vehicle control unit 31 corresponds to the vehicle control apparatus that executes the turning control, a control unit such as brake control unit 32, which controls braking, and control units such as motor inverters 72 and 74, which control driving, may be used as main elements that execute the turning control.

In addition, a plurality of control units may share the arithmetic processing for the turning control.

### REFERENCE SYMBOL LIST

10 Vehicle
11, 12 Front wheel
13,14 Rear wheel
31 Vehicle control unit (vehicle control apparatus, control unit)
51 Steering wheel
71 Front motor (front electric motor, front driving and braking apparatus)
73 Rear motor (rear electric motor, rear driving and braking apparatus)

1. A vehicle control apparatus provided in a vehicle including a front driving and braking apparatus that applies driving and braking force to front wheels of the vehicle and a rear driving and braking apparatus that applies driving and braking force to rear wheels of the vehicle,
wherein at primary steering, which is a state in which a steering wheel of the vehicle is rotated from a neutral position in one of right and left directions, a control unit provided in the vehicle control apparatus calculates first braking force generated by the front driving and braking apparatus and first driving force generated by the rear driving and braking apparatus, based on a speed of the vehicle and physical quantities relating to a steering angle of the vehicle, and outputs a first control command for generating the first braking force and the first driving force.

2. The vehicle control apparatus according to claim 1, wherein at secondary steering, which is a state in which the steering wheel is rotated in the opposite direction after the primary steering, the control unit calculates second driving force generated by the front driving and braking apparatus and second braking force generated by the rear driving and braking apparatus, based on the speed and the physical quantities relating to the steering angle, and outputs a second control command for generating the second driving force and the second braking force.

3. The vehicle control apparatus according to claim 1, wherein the control unit calculates the first braking force and the first driving force, based on the speed, a steering angular velocity among the physical quantities relating to the steering angle, and the steering angle among the physical quantities relating to the steering angle.

4. The vehicle control apparatus according to claim 3, wherein when the speed is less than a predetermined first speed threshold and when the steering angular velocity is less than a predetermined first steering angular velocity threshold, the control unit outputs the first braking force and the first driving force as 0.

5. The vehicle control apparatus according to claim 4,
wherein when the speed is greater than the first speed threshold and is less than a predetermined second speed threshold greater than the first speed threshold, the control unit increases the first braking force and the first driving force as the speed increases,
wherein when the speed is greater than the second speed threshold, the control unit decreases the first braking force and the first driving force as the speed increases,
wherein when the steering angular velocity is greater than the first steering angular velocity threshold and is less than a predetermined second steering angular velocity threshold greater than the first steering angular velocity threshold, the control unit increases the first braking force and the first driving force as the steering angular velocity increases, and
wherein when the steering angular velocity is greater than the second steering angular velocity threshold, the control unit decreases the first braking force and the first driving force as the steering angular velocity increases.

6. The vehicle control apparatus according to claim 3, wherein the control unit increases the first braking force and the first driving force as the steering angle increases.

7. The vehicle control apparatus according to claim 3, wherein the control unit decreases the first braking force and the first driving force as friction braking force based on a brake operation quantity of the vehicle increases.

8. The vehicle control apparatus according to claim 3, wherein the control unit calculates the first braking force and the first driving force in view of a predetermined limitation in a system of the vehicle.

9. The vehicle control apparatus according to claim 1, wherein the control unit outputs the first braking force and the first driving force after equalizing magnitude of the first braking force and magnitude of the first driving force.

10. The vehicle control apparatus according to claim 1, wherein the control unit distributes magnitude of the first braking force and magnitude of the first driving force at a predetermined distribution ratio, and outputs the first braking force and the first driving force.

11. The vehicle control apparatus according to claim 2, wherein the control unit obtains the second driving force and the second braking force by selecting a higher one of driving and braking force based on the speed and the physical quantities relating to the steering angle and a limited driving and braking force value obtained by limiting change of the driving and braking force.

12. The vehicle control apparatus according to claim 1, wherein the front driving and braking apparatus is a front electric motor, and the rear driving and braking apparatus is a rear electric motor.

13. A vehicle control method executed by a control unit mounted in a vehicle, the vehicle control method comprising applying braking force to front wheels of the vehicle and driving force to rear wheels of the vehicle when a steering wheel of the vehicle is rotated at 60 deg/s while the vehicle is running at 60 km/h.

14. The vehicle control method according to claim 13, comprising setting greater braking force applied to the front wheels of the vehicle and greater driving force applied to the rear wheels of the vehicle when the steering wheel is rotated at 70 deg/s, compared with the case in which the steering wheel is rotated at 60 deg/s.

15. A vehicle control method executed by a control unit mounted in a vehicle, the vehicle control method comprising applying driving force to front wheels of the vehicle and braking force to rear wheels of the vehicle when a steering wheel of the vehicle is rotated clockwise at 60 deg/s and is rotated counterclockwise at 60 deg/s while the vehicle is running at 60 km/h.
